(19) United States
(12) Patent Application Publication
(10) Pub. No.: US 2007/0094351 A1
(43) Pub. Date: Apr. 26, 2007

(54) METHOD OF NAVIGATING THROUGH CONTENT OF CELLULAR NETWORK

(76) Inventors: Dan Kalish, Rannana (IL); Yaron Kalish, Haifa (IL); Eyal Brosh, Herzliya (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/550,511

(22) Filed: Oct. 18, 2006

Related U.S. Application Data
(63) Continuation-in-part of application No. 09/713,275, filed on Nov. 15, 2000.

(51) Int. Cl. G06F 15/16

(52) U.S. Cl. 709/218

(57) ABSTRACT

The present invention discloses a method for enabling a mobile communication device, dynamic navigation between wireless network pages of content provider and advertising agency. Said method includes the steps of maintaining the last network page address visited by a specific user at content publisher network site and editing the advertising agency network pages which where requested by said user to include navigation hyperlinks to the last maintained address of said user. The editing process is preformed at the proxy server which serves as the gateway server of the cellular phone. The edited pages include hyperlink navigation address of the last content page the user visited. Hence, once the user wishes to return to the content site, where he started to navigate to advertisement site, he can click on added hyperlink and return directly to the last visited content page.

This application is a continuation-in-part (CIP) of U.S. application Ser. No. 09/713,275, filed Jun. 05, 2000, the disclosures of which are hereby incorporated herein by reference.

### BACKGROUND OF THE INVENTION

The present invention relates to wireless networks navigating practices. More specifically, the invention relates to methodologies and utilities for exploring and orienting through content of wireless networks.

WAP defines a communications protocol as well as an application environment. In essence, it is a standardized technology for cross-platform, distributed computing. WAP is very similar to the combination of TCP/IP and HTTP except that it adds in one very important feature: optimization for low-bandwidth, low-memory, and low-display capability environments. These types of environments include PDAs, wireless phones, pagers, and virtually any other communications device.

WAP client applications make requests very similar in concept to the URL concept in use on the Web. As a general example, consider the following explanation (exact details may vary on a vendor-to-vendor basis). A WAP request is routed through a WAP gateway which acts as an intermediary between the “bearer” used by the client (GSM, CDMA, TDMA, etc.) and the computing network that the WAP gateway resides on (The Internet in most cases). The gateway then processes the request, retrieves contents or calls CGI scripts, Java servlets, or some other dynamic mechanism, then formats data for return to the client. This data is formatted as WML (Wireless Markup Language), a markup language based directly on XML.

Once the WML content (known as a deck) has been prepared, the gateway then sends the completed request back (in binary form due to bandwidth restrictions) to the client for display and/or processing. The client retrieves the first card off of the deck and displays it on the monitor.

The deck of cards metaphor is designed specifically to take advantage of small display areas on handheld devices. Instead of continually requesting and retrieving cards (the WML equivalent of HTML pages), each client request results in the retrieval of a deck of one or more cards. The client device can employ logic via embedded WML Script (the WAP equivalent of client-side JavaScript) for intelligently processing these cards and the resultant user inputs.

To sum up, the client makes a request. This request is received by a WAP gateway that then processes the request and formulates a reply using WML.

When ready, the WML is sent back to the client for display. As mentioned earlier, this is very similar in concept to the standard stateless HTTP transaction involving client Web browsers.

As known, when conventionally surfing through the web, the user navigates easily from one web page to another using the browser navigation utilities such as back and next, in contrast, when surfing through wireless networks using micro-browsers on constrained devices, e.g. wireless phones, even basic navigation utilities are not available since Wireless phones have size, weight and cost constraints which limit the memory and processing capabilities they possess. Furthermore, the diversity of devices and of user interfaces of micro-browsers (menus buttons etc.) creates a situation where the user is highly dependant on the actual content provided in the WML deck for his orientation and navigation.

As a result of these navigation constraints the users are generally restricted to the content provided by wireless communication and content suppliers. In most cases the user is enabled to navigate only to content providers having commercial engagements with the wireless communication suppliers. As a result cross-site navigation is virtually impossible.

Furthermore the navigation constraints make simple surfing activities almost impossible, for example the option of going through a search result or any list of links. Once selecting a link there is no promise to the user that the content he is directed to will feature a “back” button. Thus when following a link he may be rendered unable to return to the list he was going through.

It is thus the prime object of the invention to provide a method and system for maximizing the Internet access capabilities of these wireless phone devices and various other constrained devices while maintaining a small memory and CPU footprint.

It is thus a further object of the invention to provide navigation utilities enabling efficient navigation through a wireless network or when using various constrained navigation devices.

It is a further object of the invention to provide a method of accelerating the delivery of content to the user of such network

### SUMMARY OF THE INVENTION

The present disclose a method for enabling a mobile communication device, a dynamic navigation between wireless network hyper text language based pages (“network page”) by a proxy server, said proxy server enabling receiving user requests for network pages from the mobile device and returning the requested network pages content, wherein at least part of the pages are originated by a content publisher which include dynamic hyperlinks to network pages which are originated by an advertising agency. The method according to the present invention comprises the following steps of: maintaining last address of a content publisher network page visited by a specific user and editing advertising agency network pages which where request by said user to include navigation hyperlinks to the last maintained address of said user.

According to some embodiment of the present invention the method further include the steps of: Identifying current geographic location of mobile devices and editing the content publisher network pages to include at least one hyperlink to advertising agency network page having relevancy to user current location.

According to some embodiment of the present invention the method further include the steps of: Identifying profile of mobile devices user, and editing the content publisher network pages to include at least one hyperlink to advertising agency network page which has relevancy to user profile.

According to some embodiment of the present invention the method further includes the steps of: Identifying content of current network page visited by a specific user, and editing the content publisher network pages to include at least one hyperlink to advertising agency network page which has relevancy to identified content context.

According to some embodiment of the present invention the method further include the step of: exchanging URLs ' references of embedded objects to absolute URL references.

According to some embodiment of the present invention the method further include the step of: Further editing of page hypertext content by modifying URLs of “hyperlinks” so as to point to the location of the proxy.

According to some embodiment of the present invention method further include the steps of: aggregating and organizing collection of network pages which were visited by the user (“track pages”) into sequences of network pages hyperlinks URLs (“navigation track”), and maintaining said hyperlinks through user navigation session.

According to some embodiment of the present invention the method further includes the step of: selecting the hyperlinks to be maintained, wherein the selection is based on predefined rules in accordance with site content.

According to some embodiment of the present invention the method further includes the step of: downloading the next-in-line pages along navigation track concurrently with the downloading of the current track page.

According to some embodiment of the present invention the method further includes the step of: organizing several track pages into one track page wherein the size of the united track page is limited according to the mobile device constrains.

According to some embodiment of the present invention method further include the step of: editing the network page to include navigation items directing to navigation track from proxy server.

According to some embodiment of the present invention the method further includes the step of: recording and maintaining user selections of advertisements hyperlinks and selecting the advertisement hyperlinks to be added to edited web pages, wherein the selection is based on analysis of specific recorded user selections.

According to some embodiment of the present invention the method further includes the step of: recording and maintaining user selection of advertisements hyperlinks and selecting the advertisement hyperlinks to be added to edited web pages, wherein the selection is based one analysis of recorded users selection finding correlation between users having common preferences.

According to some embodiment of the present invention discloses a method for enabling a mobile communication device, a dynamic navigation between wireless network hyper text language based pages (“network page”) by a proxy server, said proxy server enabling receiving user requests for network pages from the mobile device and returning the requested network pages content, wherein at least part of the pages are originated by a first content publisher which includes dynamic hyperlinks to network pages which are originated by a second content publisher. The method includes the steps of Maintaining last address of a content publisher network page visited by a specific user; and editing second content publisher network pages which where request by said user to include navigation hyperlinks to the last maintained address of said users.

### BRIEF DESCRIPTION OF THE DRAWINGS

These and further features and advantages of the invention will become more clearly understood in the light of the ensuing description of a few preferred embodiments thereof, given by way of example only, with reference to the accompanying drawings, wherein

FIG. 1 is a general diagrammatic representation of the environment in which the present invention is practiced;

FIG. 2 is a flow-chart of page pre-processing according the present invention;

FIG. 3 is a flow-chart of starting track-navigation process without caching;

FIG. 4 is a flow-chart of processing for each user request;

FIG. 5 is a flow chart of processing done for a user track navigation request. E.g. “Next”/“Previous”;

FIG. 6 is a flow-chart of processing done for a user request of following a link of the hypermedia source;

FIG, 7 is a flow-chart of processing done for a user request to view the navigational track;

1 FIG. 8 is a flow-chart of processing done for a user request to re-load the current trail sequence from the source of the track sequence;

FIG. 9 is a flow-chart of starting trail-navigation process with caching and pre-fetching of pages;

FIG. 10 is a flow-chart of processing for each user request with caching and pre-fetching of pages;

FIG. 11 is a flow chart of processing done for a user trail navigation request. E.g. “Next”/“Previous” with caching and pre-fetching of pages;

FIG. 12 is a flow-chart of processing done for a user request of following a link of the current hypermedia source with caching and pre-fetching of pages;

FIG. 13 is a flow-chart of processing done for a user request to view the navigational trail with caching and pre-fetching of pages;

FIG. 14 is a flow-chart of processing done for a user request to re-load the current trail sequence from the source of the trail sequence with caching and pre-fetching of pages;

FIG. 15 is a flow-chart of processing done to allow further client acceleration through concatenation of WML cards into larger decks;

### DETAILED DESCRIPTION OF THE PREFERRED EMBODIMENTS

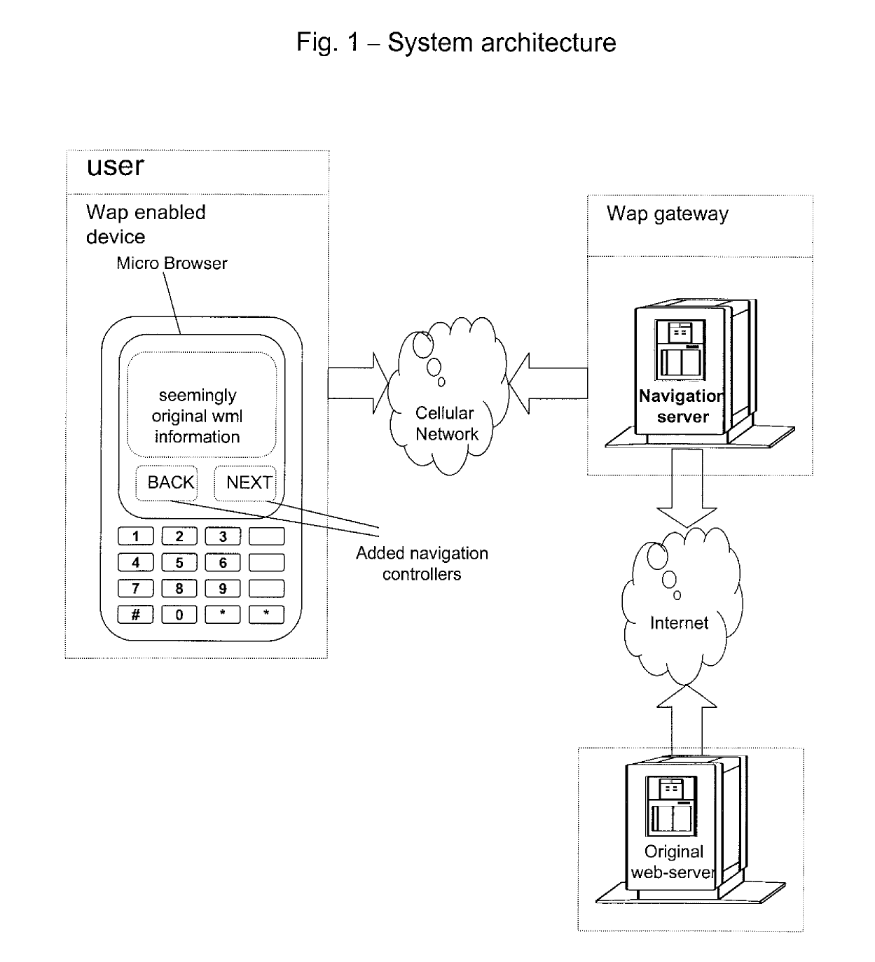

FIG. 1 illustrates one possible network configuration, in which the present invention can be implemented.

Referring to FIG. 1 of the drawings, it will be seen that a user A is connected through cellular network B to designated server (hereinafter called “the navigation server”), this server serves as an intermediator gateway between the user mobile device (hereinafter called “the user agent”) and the Internet web servers containing data available for user access (hereinafter called “the original server”).

Let us assume that the user A has placed a request for a hypertext based data file (hereinafter called the “track page”), (the most common standard for cellular networks is a WML page) which is part of a designated dynamic track (hereinafter called the “navigational track”) initiated by the navigation server.

Navigational tracks, i.e. pre-set sequences of hypermedia sources, are necessary for the implementation of the navigation method of the present invention. However, although being pre-set at the actual time of navigation, these sequences need not be determined until such time as they are to be used. Such pre-set of sequences can be originated from various sources:
1. Man-made sequence: This sequence may be prepared on a general-purpose computer using traditional navigation utilities (e.g. Explorer), Alternatively the sequence may be entered from the constrained device either by way of keying in each nodes data or by way of a provision amongst the navigational aids for selecting designated or current URL as a node in the sequence. For example such a track of hypermedia links might be the persons personal information services e.g. stocks, local weather, etc.
2. Mechanically produced on demand resource locators (on demand track): A group of resource locators may be provided in form of a hypermedia source, or in any other computerized media and format accessible to the navigation server at the time of track creation. For clarity, take the example of location-based services for mobile users. For instance a person roaming the streets with a mobile hand set might want to view a sequence of upscale restaurants in his vicinity. Given a computerized service capable of providing the raw data comprising required restaurants, for instance by way of database query provided users location and required class of restaurants, a navigational trail may be created on the fly from said query result.
3. Search results: In this case the required collection of hypermedia links may be extracted from the hypermedia source that is the final output of the search engine, or from any intermediate interior representation of said collection of links, such as a database query result.
4. Any network information source: transformed, for or by the navigation server, into the hypermedia format appropriate for the user agent. An example of such implementation might be a users email inbox, from which each individual email can be accessed, if necessary translated into appropriate hypermedia representation, and linked together with all the other emails to form a trail. Thus enabling the user to browse conveniently and in an accelerated manner through his/her pending mail.

According to the prior art routine, when a user places a request for a WML page through wireless network, after receiving the requested page, the navigation capabilities were limited. The user can't always back trace his foot steps or easily go through a list of hyperlinks. Once the user selected one hyperlink it is not promised that he can return to the original hyperlinks list in one or two click operation.

Taking into consideration that a certain time lag is involved in downloading each WML page it will be appreciated that this process is cumbersome and time consuming.

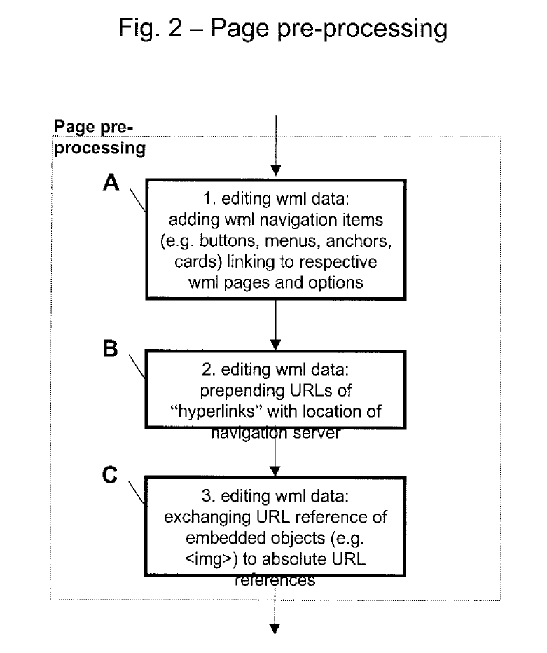

Accordingly, it is herein proposed that before transmitting the track page through the wireless network the page is modified according to the process illustrated in Fig.2 (hereinafter call “the Editing Process”). The editing process serves two major purposes: first, to add navigation provisions into the original page, providing the user with various one click navigation utilities such as next or back buttons, more advanced utilities are described further bellow. Second, editing the hyperlinks URLs of the original page to force their targeted hyperlink page to be passed to the navigation server. As a result the hyperlink target page will be modified according to said editing process. This procedure enables the user to keep the one click added navigation utilities, even when navigating outside of the pre-planned navigation track.

The first purpose, that of adding navigation provisions, is achieved by operation A as illustrated in FIG. 2.

Operation A is at the heart of the navigation provisioning. This is the process in which navigation elements are added to the hypertext source to allow for it to be presented as part of the track context.

There are several possible ways for implementing the added provisions depending on the specific markup language in use, on the data transfer protocol, and on the capabilities of the said navigational device.

For the sake of clarity we shall detail one such possible implementation, using WML as markup language, WAP protocol for data transfer and the WAP enabled mobile phone as navigational device in which the programming and storage capabilities of the device are constrained (such that the management of the navigation process is best handled on the server.)

First possible added provision is “Next” utility, which might be implemented as a navigation item addressed to the Navigation Server application, this navigation item comprises a first code representing the current location of the user amongst the track nodes and a second code representing the request of moving forward along the navigational track. According to alternative way, the navigation server might maintain an internal state indicating the user's current location within the navigation track (a current location code), the current location code can be extracted from any of a variety of user identifying characteristics (e.g. ISDN number, session id, SIM, and so forth, all dependent on the availability of such) coupled with the current location code of said user. The server in response to such forward request would alter the current location code to represent the new user agent location, and would return to the user the WML page appropriate for the new location.

In the above said constellation a “Show map” utility (as described down bellow) could be implemented as a navigation item addressed to the Navigation Server application, where the navigation item comprises a first code representing the current location of the user amongst the track nodes and a second code represents the request for viewing the map of the track. Alternatively the above-mentioned user identification mechanisms are applicable. The server, in response to such request, would prepare a WML deck representing the navigational track (“track map page”) and return the latter to the user device. The track map page would contain links representing navigation track nodes, where each node's link would pass to the Navigation Server a request comprising a first code representing the request for relocating the user agent to this node and a second code representing the requested new location of the user. The server in response to such request would alter its current location code to represent the new user agent location and would return the WML page associated with the new location to the user. In the above said constellation said “Reload track” utility (as described down bellow) could be implemented as a navigation item addressed to the Navigation Server application, where the navigation item comprises a code representing the users request to reload the current navigation track. The server in response to request would again perform the process by which the current track was originally composed. Might this be loading a pre-prepared static representation of the navigation track, or any sequence of queries or procedures performed to comprise said track, as described above in section dealing with sources for navigational track.

The second purpose, that of redirecting the links, is achieved by operation B.

In the navigational provisioning described in this document, maintaining user orientation along the entire navigation process is an important feature. Given that the method described herein permits constraint-free navigation by following all hyper-media links of potential hypertext sources, a method is provided for maintaining said navigational orientation and navigational provisions for all hyper-media links accessible along the navigation session.

Operation B provides method for such context maintenance. In this modification process, the hypermedia source is scanned for detecting all elements of the markup language (appropriate for said hypermedia source) enabling redirection of the user agent to an alternate hypermedia source. Said hypermedia links are each replaced with a request to the navigation server, in which the alternate hypermedia source location identifier is passed as a parameter to the server. The server in response to such “Follow-link” request would retrieve requested hypermedia source, specified by parameter, from designated server and perform on it the same process described herein. There are several possible ways for implementing the described process depending on the specific markup language in use, on the data transfer protocol, and on the capabilities of the said navigational device. For the sake of clarity we shall detail one such possible implementation, wherein WML is the markup language, WML is the transfer protocol used for data transfer and WAP enabled mobile phone as navigational device in which the programming and storage capabilities are constrained (such that the management of the navigation process is best handled on the server.)

In this constellation all WML elements of the WML deck being loaded and which enable loading of a new URL will be searched and replaced. Each relative URL would first be expanded to absolute form and would be passed as a parameter in a substituted URL pointing to the Navigation Server application. Upon receipt of such a request the navigation server would retrieve the original URL parameter from the request and read the requested WML source from the designated server. The server would then perform on the source the same process described herein and return the resulting WML deck to the user, thus maintaining the user context and navigation provisions.

The above actions are complemented by operation C as illustrated in FIG. 2.

The above-mentioned modifications of processes A and B provide for user navigational aids and for maintaining user context while allowing free surfing in and out of the trail. For these processes all requests of the user agent are directed at the Navigation Server. In the hypermedia source there might be references to embedded objects that need not be accessed through the Navigation Server. In such case, since these embedded objects might be bundled on a computer with the hypermedia source, the user agent may request them from the Navigation Server by its default behavior. To alleviate unnecessary traffic through the Navigation Server, and to expedite these embedded objects delivery, the hypermedia source may be altered in such a way as to instruct the user agent to retrieve said embedded objects from the original server from where the hypermedia source was retrieved.

According to alternative mode of operation C enabling to achieve acceleration of downloading embedded objects, by caching them at the navigation server together with the hypermedia source in which they are embedded, the navigation server may retrieve the embedded objects when they are encountered in the hypermedia source and cache them locally. As the user agent requests these embedded objects, they may be provided to the user agent from the cache of the Navigation Server. In such case the hypermedia links of said embedded objects would not be altered to instruct the user agent to retrieve said embedded objects from the original server.

For the purpose of clarity and exemplification, in the constellation described for modifications A and B above, such embedded objects would be image elements of the WML source, denoted by the <img> WML tag. In order to instruct the user agent to extract such embedded images directly from the original WML server, the URL denoting the source from which to read the image (as represented by the “ref” attribute of the <img> tag) would need to be replaced with the corresponding absolute URL reference to the image source.

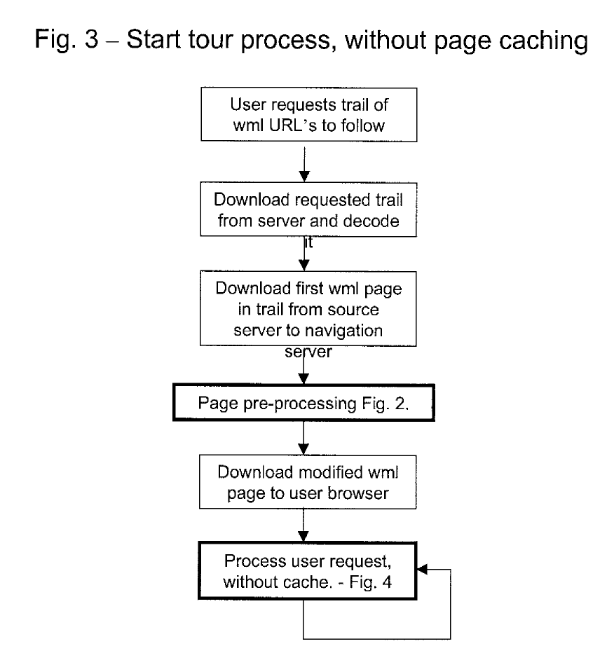

For example let us assume that the user has chosen an on-demand track of WML pages, the procedure as illustrated in FIG. 3, takes place. The Navigation Server receives the users request for a track category. The server generates a dynamic sequence of WML page URLs adjusted according to up-to-date time and place, and user personal preferences. Let us assume the user requested a tour of restaurants in his vicinity, hence the sever will generate a track of WML pages providing the user with information of near by Italian (according to the user preference) restaurants open at the current time. The newly created track is decoded and temporarily maintained in the navigation server memory associated with requesting user's ID.

(The tour category request can be further improved to serve for returning a search query. Once the navigating server receives query request, it is transmitted to appropriate search engine located on the original search server. The result search list received by the navigation server is dynamically processed and a respective track comprising the search result URL's is created. Optionally before transmitting the first track page as described down bellow the track map is transmitted in the form of WML page containing hyperlinks, this page is processed according to the Editing Process. This enables for direct access to any of the returned URL's while in the context of the track.)

The first track page is downloaded from the original web server to the navigation server and processed according to the Editing Process. The modified track page is transmitted to the user through the wireless network.

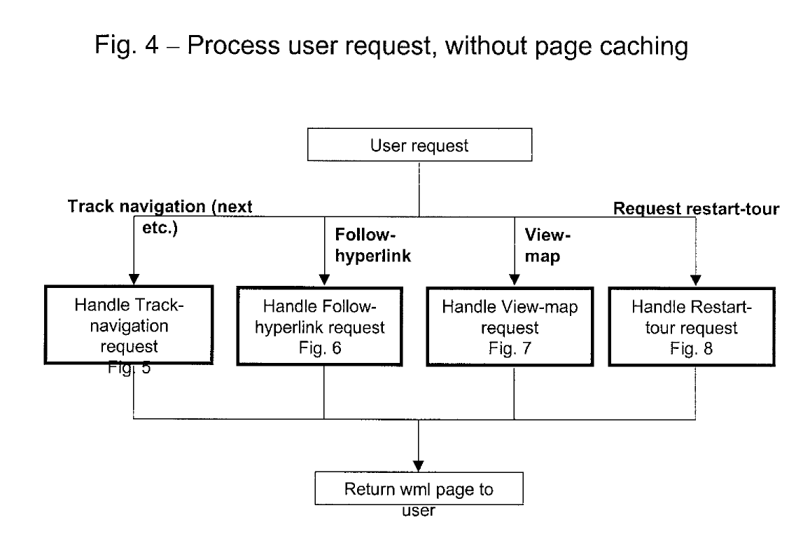

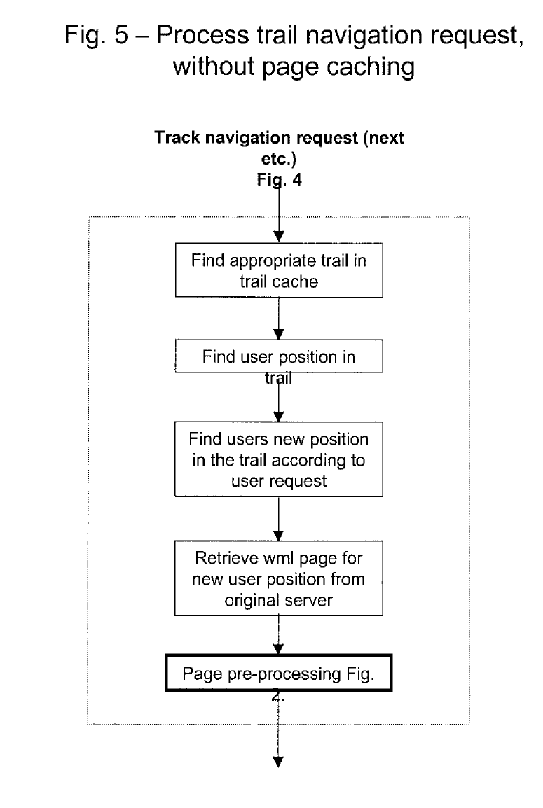

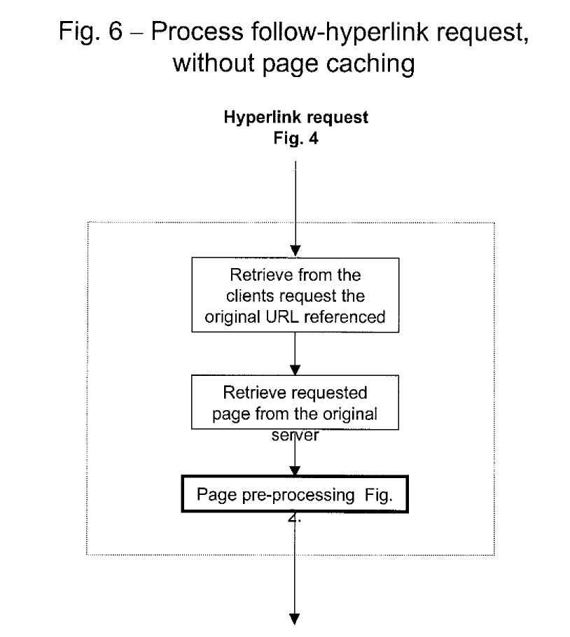

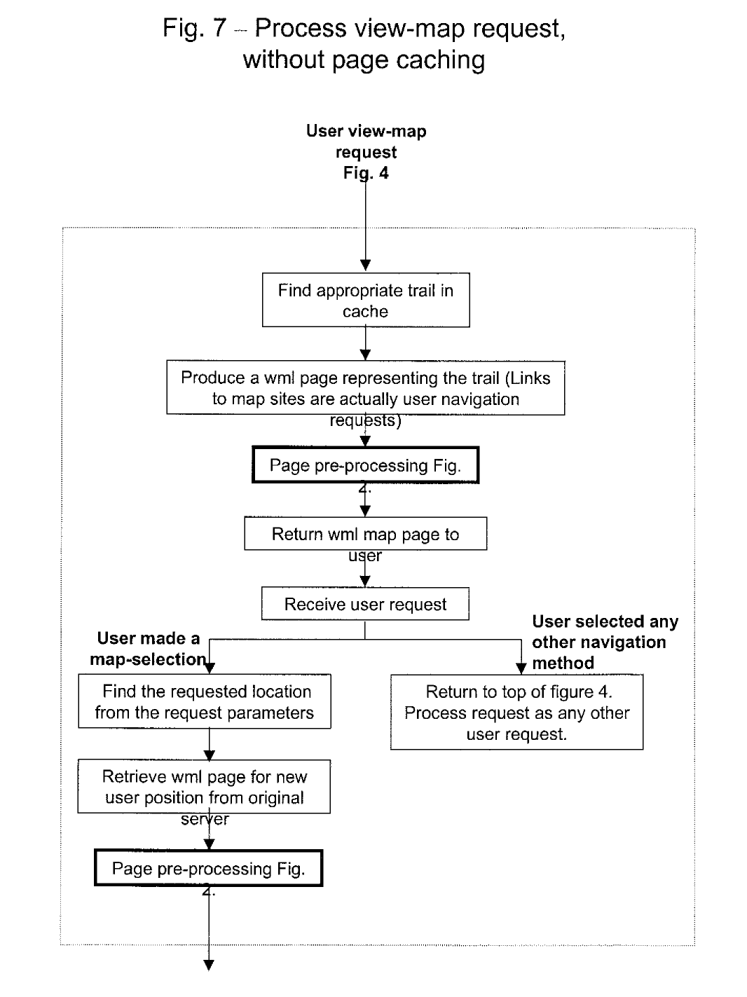

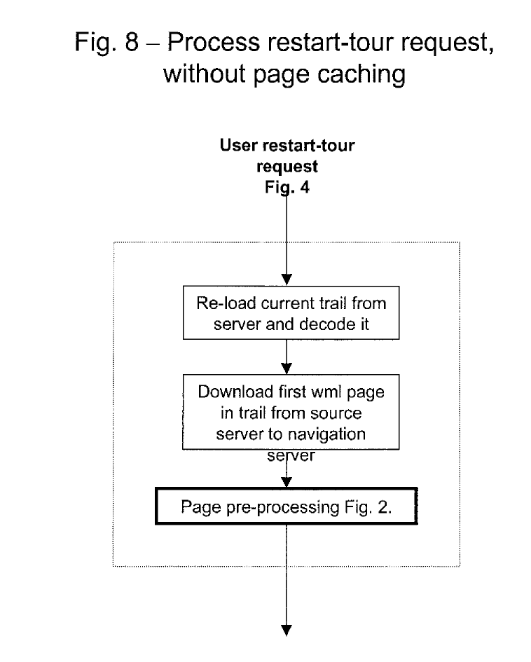

Once provided with modified track page the user has four alternatives (equivalent to respective added provisions as described above) as illustrated in FIG. 4. The first option for selecting one of the navigation buttons is illustrated in FIG. 5. Upon receiving the navigation request, the navigation server identifies the respective track and traces user current position in the track.

According to the respective track details, the users current position and the users navigation request, the respective target track page is retrieved from the original server. The target track page is modified according to the Editing Process and transmitted to the user mobile device.

The second option of re-starting the track is illustrated in FIG. 8, this process is equivalent to the previous process, but the target track page is always the first track page. Furthermore, the track itself is refreshed on the server to provide for tracks that can change while the user is navigating, for instance due to time elapsing, location changing, or manual alteration of the track.

The third option provides the user with a map of the current track as illustrated in FIG. 7. Upon receiving the user request, the navigation server produces a WML page representing the track stops, each stop representation acts as conventional hyperlink. A users selection of a map hyperlink will instruct the server to transfer the user to that node and context of the track. The map can be displayed as a simple list of links, as a tree directory, or as a directed graph wherein stops are represented by graph nodes, and the track direction by respective arrows. All as suitable for user preferences and to the rendering capabilities of the device.

The fourth option as illustrated in FIG. 6 resembles the conventional way of selecting hyperlinks, however when selecting the hyperlinks the user is provided with the same navigation utilities as provided by a track page. After the user has placed a request to navigate to one of the hyperlinks the target page is processed according to Editing Process.

The editing process can take place at the navigation server or alternatively at the cellular device, depending on the cellular device processing-power and memory limitations.

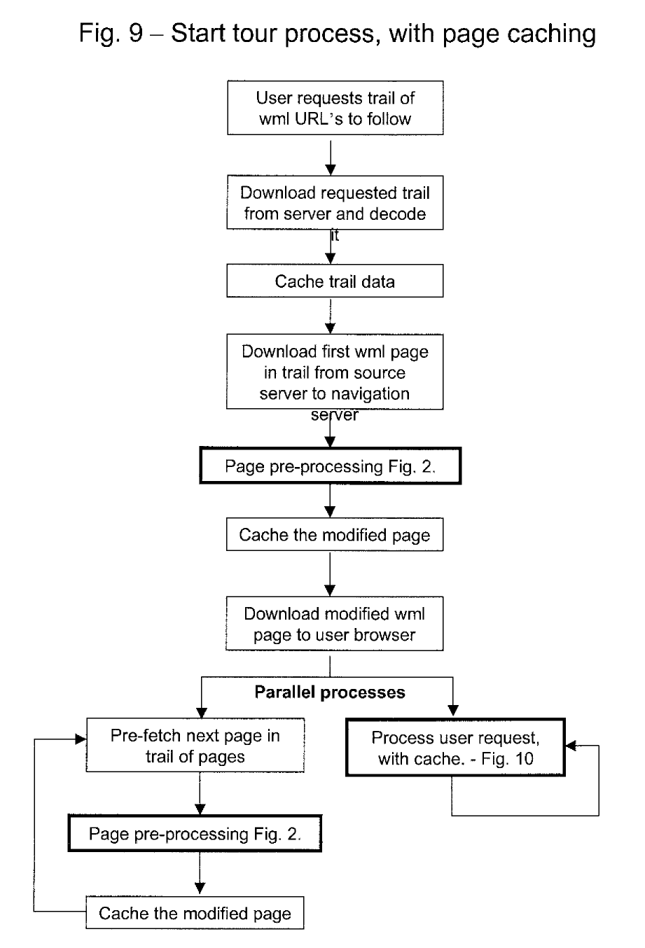

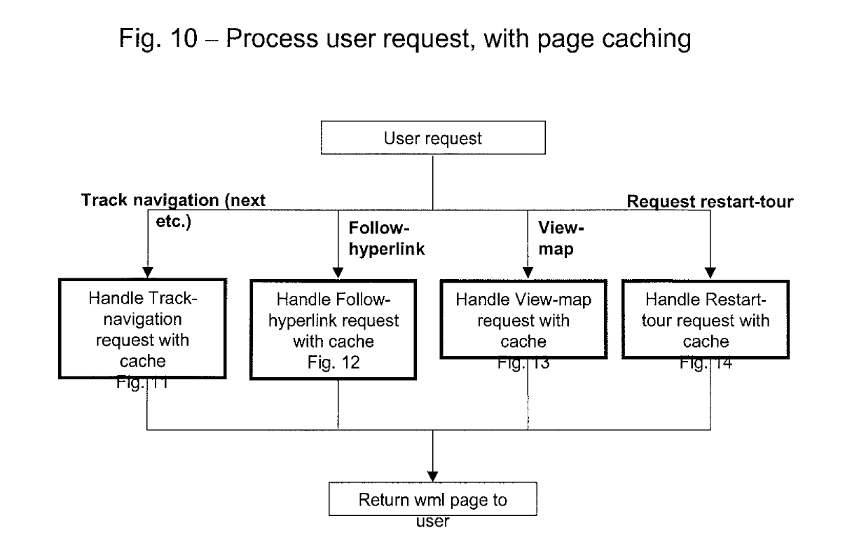

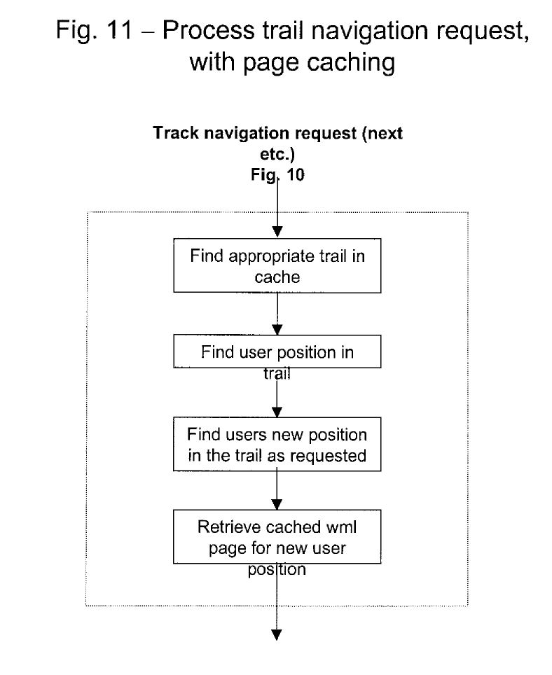

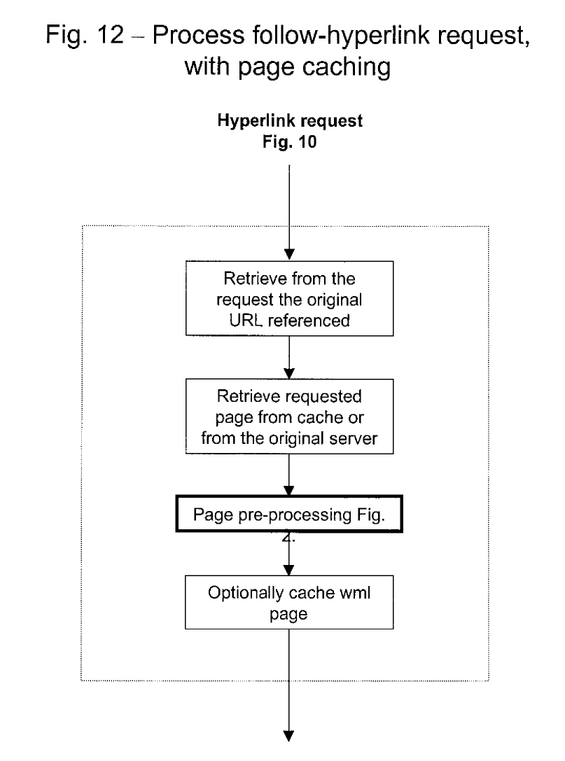

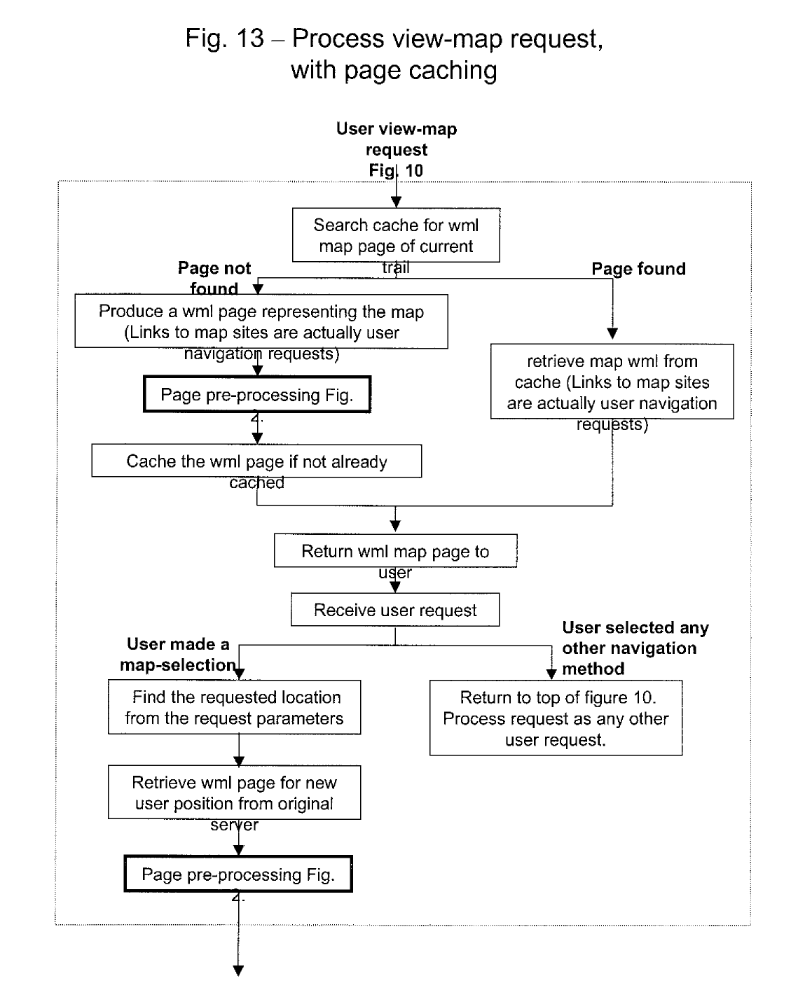

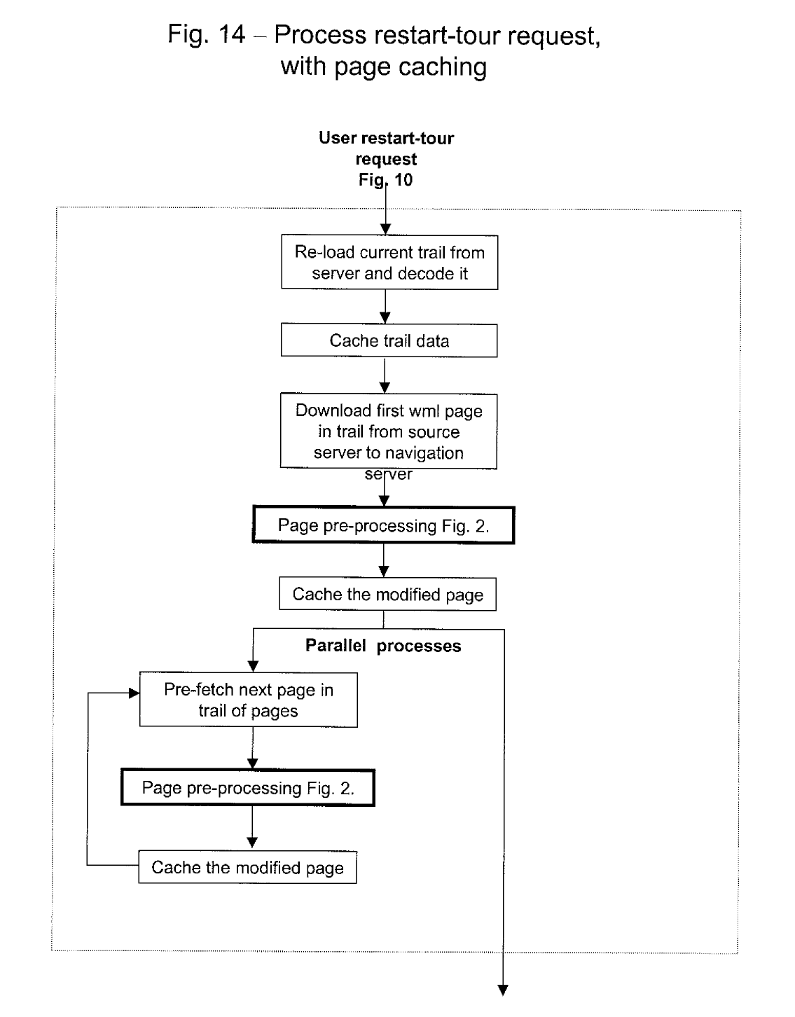

According to a further improvement offered by the present invention, it is enabled that after downloading the first requested track page, the navigation server automatically pre-fetch the next in-line track pages, the downloaded pages are processed according to the Editing Process and maintained in the cache memory of the navigation server. As a result, when the user requests the next track page or even a further page of the track, the navigating server checks the local cache, in case the requested page exists in cache memory it is instantly transmitted to the user. This improvement results in a much more efficient and fast process of providing the user with the requested track pages. The complete procedures of navigating according to this improvement are illustrated in FIGS. 9,10,11,12,13 and 14.

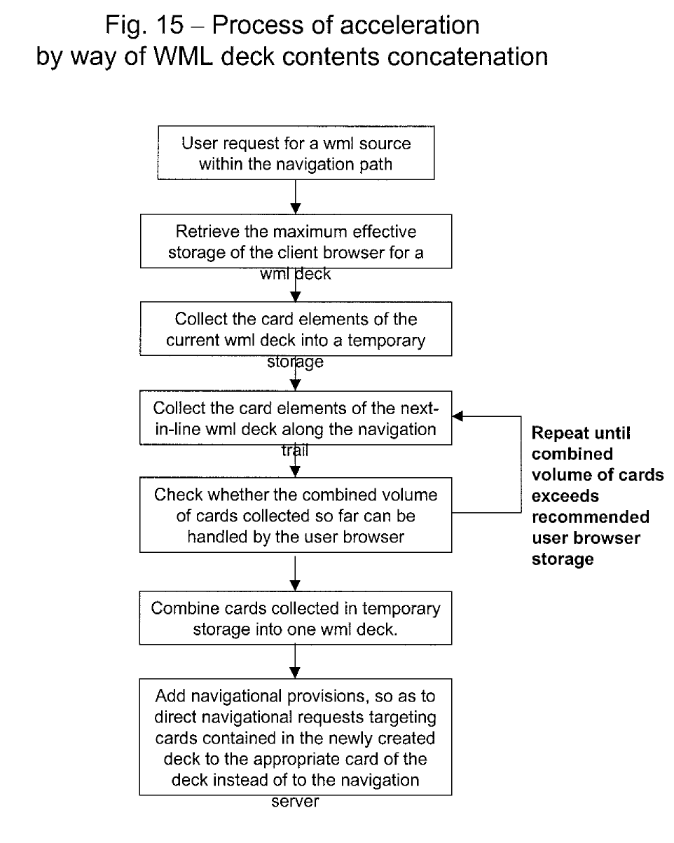

According to another improvement offered by the present invention, it is proposed to merge several track pages into one track page (hereinafter called the “united track page”) in which all cards of several original track pages are integrated together. This integration process, as illustrated in FIG. 15, is applied according to the memory limitation of user agent, the number of integrated pages is constrained by the memory capabilities of the user agent.

The advantages of this integration process are clear. Once the user requests the next-in-line track page, its content already exists in user-agent memory, the time lag of transferring the track page from the navigation server to the user agent is spared. Further more this process spares the need to apply the editing process separately to each track page, the editing process is applied only to the united track page.

According to further embodiment of the present invention the navigation platform as described above can be implemented for creating efficient connection between the entities which provide original content to the wireless network , whereby each entity has independent navigation platform. Such entities may have interest to have dynamic navigation hyperlinks connecting between the network pages content sites on occasional basis according to commercial needs. A good example for such situation are content providers and advertising agencies. Advertising hyperlinks appear at different content network pages associated with different content providers, hence if the user navigated from a specific content site to an advertisement content, he might find it difficult to return to the content site were he started his navigation route. Back navigation option is not always available using micro-browser in cellular phone and even if it exists, the user may have to operate the back option several times before he returns to the content network pages. It is suggested according to the present invention to use the navigation platform as described above. More specifically it is suggested to maintain the addresses of the last visited network pages of content sites and edit the network pages of the advertising agency before they are transmitted to the user to include hyperlinks of the maintained addresses. The editing process is preformed at the proxy server which serves as the gateway server of the cellular phone. The edited pages include hyperlink navigation address of the last content page the user visited. Hence, once the user wishes to return to the content site, where he started to navigate to advertisement site, he can click on added hyperlink and return directly to the lasted visited content page.

According to further embodiments of the present invention it is suggested to maintain the addresses of more than one network page address, enabling to create a collection of network pages addresses which represent the track of navigation the user has passed through his surfing session. This navigation track which includes the network pages address can be added to the current network page or optionally can be accessed through an added hyperlink of the current network page added to the currently visited network page. According to some embodiments of the present invention not all network pages of the user session are recorded, the proxy server may record selectively only part of the address in accordance with the context of the page or type of the page, for example advertisement network page may be excluded from the track or only homepages of network site may be recorded.

When the user navigates though the maintained track of addresses the micro-browser may download the next inline pages concurrently with the requested page, or while the user is viewing the current network page. For optimization of the downloading process, at least part of the network pages of the same track may be organized into one united network page, the size of the united page is limited according to cellular phone capabilities.

According to further embodiments of the present invention is further suggested to dynamically update the advertising hyperlinks of the content network pages in accordance with different attributes, such as profile of the user, location of the cellular phone or context of the network pages content.

According to some embodiments of the present invention it is suggested to record users selections of advertising hyperlinks, analyze user selections, and select the future advertising hyperlinks in accordance with said analysis.

The analysis of users selections may refers to specific user or groups of users, filtering the selection in accordance with various attributes such as location of mobile device, users profiles or context of content site

Finally, it should be appreciated that the above-described embodiments are directed at a cellular communication environment. However, the invention in its broad aspect is equally applicable to computerized network communication in general, such as satellite, blue-tooth, and others.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiments illustrated, but by the appended claims and their legal equivalents.

What is claimed is:

1. A method for enabling a mobile communication device, dynamic navigation between wireless network hyper text language based pages (“network page”) by a proxy server, said proxy server enables receiving user requests for network pages from the mobile device and returning the requested network pages content, wherein at least part of the pages are originated by a content publisher which include dynamic hyperlinks to network pages which are originated by an advertising agency, said method comprising the steps of:
Maintaining last address of a content publisher network page visited by a specific user;
Editing advertising agency network pages which where request by said user to include navigation hyperlinks to the last maintained address of said user.

2. The method of claim 1 further comprising the steps of:
Identifying current geographic location of mobile devices;
Editing the content publisher network pages to include at least one hyperlink to advertising agency network page having relevancy to user current location.

3. The method of claim 1 further comprising the steps of:
Identifying profile of mobile devices user;
Editing the content publisher network pages to include at least one hyperlink to advertising agency network page which has relevancy to user profile.

4. The method of claim 1 further comprising the steps of:
Identifying content of current network page visited by a specific user;
Editing the content publisher network pages to include at least one hyperlink to advertising agency network page which has relevancy to identified content context.

5. The method of claim 1 further comprising the step of exchanging URLs' references of embedded objects to absolute URL references.

6. The method of claim 1 further comprising the steps of:
Further editing of page hypertext content by modifying URLs of “hyperlinks” so as to point to the location of the proxy;

7. The method of claim 1 further comprising the step of:
aggregating and organizing collection of network pages which were visited by the user (“track pages”) into sequences of network pages hyperlinks URLs (“navigation track”),
and maintaining said hyperlinks through user navigation session.

8. The method of claim 7 further comprising the step of selecting the hyperlinks to be maintained, wherein the selection is based on predefined rules in accordance with site content.

9. The method of claim 7 further comprising the step of downloading the next-in-line pages along navigation track concurrently with the downloading of the current track page;

10. The method of claim 7 further comprising the steps of:
organizing several track pages into one track page wherein the size of the united track page is limited according to the mobile device constrains;

11. The method of claim 7 further including the step of editing the network page to include navigation items which hyperlink directing to navigation track from proxy server.

12. The method of claim 1 further comprising the steps of:
recording and maintaining user selections of advertisements hyperlinks;
selecting the advertisement hyperlinks to be added to edited web pages, wherein the selection is based on analysis of specific recorded user selections.

13. The method of claim 1 further comprising the steps of:
recording and maintaining user selection of advertisements hyperlinks;
selecting the advertisement hyperlinks to be added to edited web pages, wherein the selection is based one analysis of recorded users selection finding correlation between user having common preferences.

14. A method for enabling a mobile communication device, dynamic navigation between wireless network hyper text language based pages (“network page”) by a proxy server, said proxy server enables receiving user requests for network pages from the mobile device and returning the requested network pages content, wherein at least part of the pages are originated by a first content publisher which includes dynamic hyperlinks to network pages which are originated by a second content publisher, said method comprising the steps of:
Maintaining user current address of the first content publisher network page of a specific user;
Editing second content publisher network pages which where request by said user to include navigation hyperlinks to the last maintained address of said users.
